(19) United States
(12) Patent Application Publication
(10) Pub. No.: US 2014/0106836 A1
(43) Pub. Date: Apr. 17, 2014

(54) GAMES FOR EVALUATING FINANCIAL FORECASTING SKILL

(71) Applicant: Nous Global Limited, Tortola (VG)

(72) Inventors: Justin Short, Tokyo (JP); Alexander Braylan, Tokyo (JP); Xiaofeng Xu, Kowloon (HK); Anthony Lenaghan, Normanby (GB); Ming Hiu Yau, Kowloon (HK)

(21) Appl. No.: 14/051,714

(22) Filed: Oct. 11, 2013

Related U.S. Application Data
(60) Provisional application No. 61/712,989, filed on Oct. 12, 2012.

(51) Int. Cl. A63F 13/30

(52) U.S. Cl. CPC A63F 13/12
USPC 463/9

(57) ABSTRACT

A computer-implemented game system enables users to simulate the trading of financial instruments in a financial market. Among other things, the system simulates the purchasing of a financial instrument, the specification of conditions for holding or selling the financial instrument, and the selling of a financial instrument to realize simulated gains and losses. The performance of each user is tracked and displayed, such that users can compare their performance against other users. The performance of each user is used to determine a payout for that user.

### TECHNICAL FIELD

This disclosure relates to games for evaluating financial forecasting skill.

### BACKGROUND

Financial markets are an effective solution to the problem of allocating investment capital in a modern economy. Skilled traders and financial forecasters thus provide a valuable service to the larger economy by directing capital to where it will be most valuable. Trading games are one way to determine if an individual has the potential to become a skilled financial forecaster. However, lack of access and early losses due to bad luck or other factors can prevent some people from becoming skilled forecasters or traders.

### SUMMARY

The present disclosure describes implementations of a game system that simulates the trading of financial instruments in a financial market. Among other things, the system simulates the purchasing of a financial instrument, the specification of conditions for holding or selling the financial instrument, and the selling of a financial instrument to realize simulated gains and losses.

Some implementations of the game system can encourage new and inexperienced users to play in various ways, for instance by making the game easier to play for beginners and increasing the difficulty as the user gains experience. Some embodiments of the game system track the performance of each user, such that users can compare their performance against others and/or compete for performance-based awards.

The game system that we describe here may encompass one or more of the following (or other) aspects, features, and implementations, and combinations of them.

In general, in an aspect, a system for playing a game includes an input module that receives a strategy from a player, the strategy including at least one trigger condition, a trigger module that determines if the trigger condition has been met, and an adjustment module that calculates a skill adjustment value based on the strategy and adjusts a skill level for the player based on the skill adjustment value.

Implementations of this aspect may include one or more of the following features. The strategy includes a confidence value. The strategy corresponds to a simulated financial transaction. The trigger condition corresponds to a condition to counteract the simulated financial transaction. The input module receives a plurality of strategies from a plurality of players, each strategy comprising at least one respective trigger condition, and the trigger module determines if each of the trigger conditions has been met, and the adjustment module calculates a respective skill adjustment value for each of the strategies and adjusts the skill level for each player based on the corresponding skill adjustment value. The system includes a leaderboard module that determines a leaderboard corresponding to the skill levels of the players. The adjustment module calculates the skill adjustment value based on a determination of a simulated valuation change of a financial instrument. The simulated valuation change corresponds to a difference in valuation between a simulated position entry time and a simulated position exit time. The simulated valuation change corresponds to a logarithm of a difference in valuation between a simulated position entry time and a simulated position exit time. The adjustment module calculates the skill adjustment value further based on a current skill level of the player. The adjustment module calculates the skill adjustment value further based on a simulated market liquidity of specific financial instruments used by the strategy. The adjustment module calculates the skill adjustment value further based on a type of the strategy. The adjustment module calculates the skill adjustment value further based on an entry cost value corresponding to a simulated transaction cost estimate. The adjustment module calculates the skill adjustment value further based on a bonus value corresponding to a difference between the simulated transaction cost estimate and a simulated actual transaction cost. The skill adjustment value is a multiple of the confidence value. The system includes a registration module that that records identifying information corresponding to one or more players. The identifying information includes a telephone number. The registration module sends a message comprising a confirmation code to a device associated with the telephone number. The registration module verifies the identifying information by receiving the confirmation code from the device associated with the telephone number. The leaderboard module determines an award and a recipient of the award based on the skill levels of the players. The leaderboard module determines the award and the receipt of the award based on a threshold skill value. Players with skill levels greater than the threshold skill value each receive corresponding weighted portions of the award, and players with a skill level less than the threshold value do not receive the award. The weighted portions of the award depend on the players' skill levels. The leaderboard module determines the award further based on the number of players. The leaderboard module determines the award and the recipient of the award further based on changes to the skill levels of the players during a pre-determined time period. The leaderboard module determines a plurality of awards and a plurality of recipients of the awards further based on changes to the skill levels of the players during each of a plurality of pre-determined overlapping time periods. The strategy corresponds to a plurality of simulated financial transactions and the trigger condition corresponds to a condition to counteract the simulated financial transactions.

In general, in another aspect, a computer-implemented method of playing a game includes receiving, in an input module a strategy from a player, the strategy including at least one trigger condition, determining, using a trigger module, if the trigger condition has been met, calculating, using an adjustment module, a skill adjustment value based on the strategy, adjusting, using the adjustment module, a skill level for the player based on the skill adjustment value, and displaying information regarding the skill adjustment value to the player through a user interface.

Implementations of this aspect may include one or more of the following features. The strategy includes a confidence value. The strategy corresponds to a simulated financial transaction. The trigger condition corresponds to a condition to counteract the simulated financial transaction. The computer-implemented method includes receiving, in the input module, a plurality of strategies from a plurality of players, each strategy including at least one respective trigger condition, determining, using the trigger module, if each of the trigger conditions has been met, calculating, using the adjustment module, a respective skill adjustment value for each of the strategies, and adjusting, using the adjustment module, the skill level for each player based on the corresponding skill adjustment value. The computer-implemented includes determining, using a leaderboard module, a leaderboard corresponding to the skill levels of the players. Calculating the skill adjustment value comprises determining, using the adjustment module, a simulated valuation change of a financial instrument. The simulated valuation change corresponds to a difference in valuation between a simulated position entry time and a simulated position exit time. The simulated valuation change corresponds to a logarithm of a difference in valuation between a simulated position entry time and a simulated position exit time. The skill adjustment value calculation is further based on a current skill level of the player. The skill adjustment value calculation is further based on a simulated market liquidity of specific financial instruments used by the strategy. The skill adjustment value calculation is further based on a type of the strategy. The skill adjustment value calculation is further based on an entry cost value corresponding to a simulated transaction cost. The skill adjustment value calculation is further based on a bonus value corresponding to a difference between the simulated transaction cost estimate and a simulated actual transaction cost. The skill adjustment value is a multiple of the confidence value. The computer-implemented method includes determining, using the leaderboard module, an award and a recipient of the award based on the skill levels of the players. Determining the award and the recipient of the award is further based on a threshold skill value. Players with skill levels greater than the threshold skill value each receive corresponding weighted portions of the award, and players with a skill level less the threshold value do not receive the award. The weighted portions of the award depend on the players' skill levels. Determining the award is further based on the number of players. Determining the award and the recipient of the award is further based on changes to the skill levels of the players during a pre-determined time period. The computer-implemented method includes determining, using the leaderboard module, a plurality of awards and a plurality of recipients of the awards further based on changes to the skill levels of the players during each of a plurality of pre-determined overlapping time periods. The strategy corresponds to a plurality of simulated financial transactions and the trigger condition corresponds to a condition to counteract the simulated financial transactions.

Among other advantages, some implementations of the game system simulate the trading of financial instruments in a financial market, and allow users to experience financial trading with relatively little personal risk. Embodiments of the game system can be based on real-world counterparts, and can include realistic representations of instruments, markets and strategies. Embodiments of the game system can encourage less experienced users to play, for example, by scaling the difficulty of the game according to the each user's skill level, and by incorporating non-linear scoring mechanisms.

The details of one or more implementations of the invention are set forth in the accompanying drawings and the description below. Other aspects, features and advantages will be apparent from the detailed description, the accompanying drawings, and from the claims.

### BRIEF DESCRIPTION OF DRAWINGS

FIG. 1 is a block diagram of a game system.

FIG. 2 is a flow chart illustrating an example usage of the game system

FIG. 3 is a flow chart illustrating another example usage of the game system.

FIG. 4 illustrates an example of a strategy selection dialog box.

FIG. 5 is a plot of an example reality value function.

FIGS. 6A-B illustrate examples of leaderboards.

### DETAILED DESCRIPTION

The present disclosure describes a computer-implemented game system that enables users to simulate the trading of financial instruments in a financial market. Among other things, the system simulates entering positions and exiting positions to realize simulated gains and losses. The performance of each user can be tracked and displayed, such that users can compare their performance against others users' performance.

Broadly, each user is assigned a “skill” value, i.e., a score value which describes the overall success of the user in playing games. The goal of a game is for a user to increase his skill level through the completion of a successful transaction (i.e., a transaction that results in a simulated gain). Each player may employ a variety of transaction strategies in order to affect his skill value, including buying and selling strategies that emulate real-world financial investment strategies. The simulated financial instruments used in a game can reflect current market conditions. Thus, a game can be used to emulate real-world investment gains and losses in a simulated game environment.

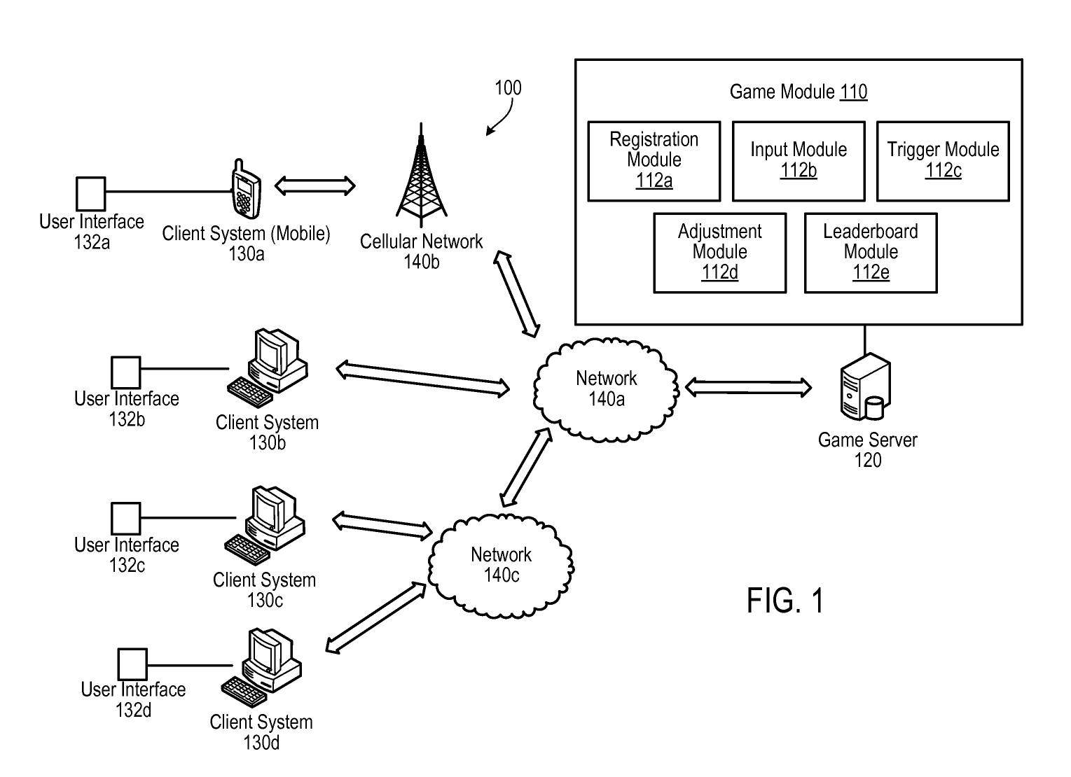

FIG. 1 illustrates an example of a system 100 that enables users to participate in games that simulate the trading of financial instruments in a financial market. The system 100 includes a game module 110 maintained on a server system 120 that includes one or more servers. Game module 110 includes several modules that perform particular functions related to the operation of system 100. For example, game module 110 can include registration module 112a, input module 112b, trigger module 112c, adjustment module 112d, and leaderboard module 112e. The modules 112a, 112b, 112c, 112d, 112e can be implemented as multiple different modules or can be part of a single module that performs the functions of each module. Server system 120 is communicatively coupled to one or more systems (e.g., client computers 130a-d) by way of one or more networks 140a-c, and can support simultaneous communications between multiple connected systems. Each client computer 130a-d includes a respective user interface 132a-d. Users can interact with user interfaces 132a-d in order to view data from game module 110, transmit data to game module 110, and issue commands to game module 110. The game server 120 can support multiple users concurrently.

Networks 140a-c can be any communications network through which data can be transferred and shared. For example, networks 140a-c can be local area networks (LANs) or wide-area networks (WANs), such as the Internet. Networks 140a-c can be implemented using various networking interfaces, for instance wireless networking interfaces (e.g., WiFi, Bluetooth, cellular, infrared, and so forth) or wired networking interfaces (such as Ethernet, serial connection, and so forth). Networks 140a-c also can include combinations of more than one network, and can be implemented using one or more networking interfaces. In an example implementation, network 140a is a WAN, network 140b is a cellular network, network 140c is a LAN, and networks 140a-c are interconnected such that any client system 130a-d can communicate with game server 120.

Server system 120 is illustrated as a single component, but can be implemented on one or more computing devices. Server system 120 can be, for instance, a single computing device that is connected to networks 140a-c, and game module 110 can be maintained and operated on the single computing device. In some implementations, server system 120 can be more than one computing device that is connected to networks 140a-c, and game module 110 can be maintained and operated on some or all of the computing devices. For instance, server system 120 can include several computing devices, and game module 110 can be distributed on one or more of these computing devices. In some implementations, server system 120 need not be located locally with respect to the rest of system 100, and portions of server system 120 can be located in one or more remote physical locations. In some implementations, one or more computing devices of server system 120 need not be located locally with respect to the rest of server system 120, and portions of server system 120 can be located in one or more remote physical locations.

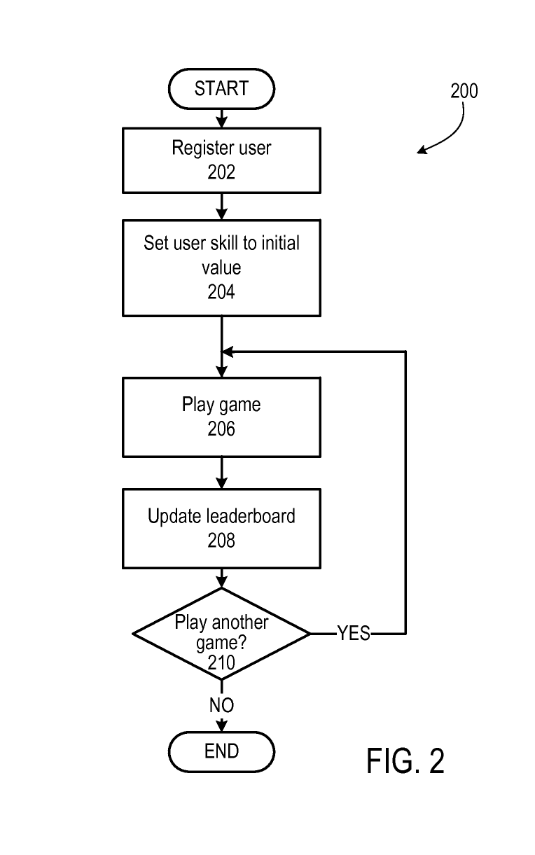

FIG. 2 shows an example process 200 implemented by system 100 for playing games. System 100 begins by registering a user (block 202) in order to enroll a user into a user account, which uniquely identifies the user and allows the user to interact with game module 110. This can be performed, for example, by registration module 112a. In an example, registration module 202a maintains a record for each user, such that the user can be uniquely identified when interacting with game module 110. For instance, in some implementations, registration module 202a maintains a record for each user that contains the user's handle (i.e., a datum that uniquely identifies the user's account), the user's authentication credentials (i.e., data that authenticates the user's identity, such as a password or personal identification number), the user's identity information (e.g., the user's name and date of birth), and contact information (e.g., the user's mailing address, telephone number, and e-mail address).

In some implementations, registration module 202a limits the number of accounts that a single user can create. For instance, during the account enrollment, registration module 202a can determine if the user's contact information is already associated with another user's account, and prevent the creation of the account. In some implementations, registration module 202a can verify the contact information, for instance by sending a message with a confirmation code using the entered contact information (e.g., by sending an e-mail message to the user's e-mail address, sending a voice or text message to the user's telephone number, sending a letter to the user's mailing address, and so forth). In order to validate his contact information, the user must transmit the confirmation code to registration module 202a. In some implementations, registration module 202a requires that the user pay a registration fee before the account is created.

After successful registration, the user is assigned an initial skill value (block 204). This can be performed, for example, by adjustment module 112d. Skill value can be of an arbitrary unit, for instance “Game Point” units. The initial skill value of each user can be assigned a pre-determined constant value, for instance zero Game Points. In some implementations, initial skill value of a user can vary depending on various factors, for instance, promotional considerations (e.g., if the user registered according a particular promotional offer), user identity (e.g., if the user is of a certain age or from a certain location), or other factors.

After the user is assigned an initial skill level, the user can use system 100 to play a game (block 206). This can be performed, for example, by input module 112b (which receives a strategy from the user), trigger module 112c (which determines if a payout event occurs as a result of the strategy), and an adjustment module 112d (which adjusts the user's skill level during the course of the game).

In general, in a single game, the user specifies a particular strategy with respect to a specified financial instrument. Instruments can include, for example, debt-based instruments (e.g., bonds, loans, bond futures, debt-based options, bills, certification of deposits, and so forth), equity-based instruments (e.g., stock, stock options, equity-based futures, and so forth), foreign exchange-based instruments (e.g., foreign exchanges, currency-based futures, and so forth), or combinations of instruments (e.g., investment vehicles such as mutual funds, exchange-traded funds, real estimate investment trusts, and so forth). Instruments can be based partially or entirely real-world counterparts (e.g., stimulated instruments based on live input data from a real financial market), or they can be entirely distinct from any real-world instrument.

A game includes starting a “strategy”. A strategy is a set of rules that ultimately determine a numerical payout value, given the instrument's value and/or transactions between the start of the game and a payout event, and is measured in the same units as the skill value (e.g., Game Points). In general, every strategy has at least one possible positive payout scenario and also can have multiple zero or negative payout scenarios. Strategies can emulate common financial investment strategies and can include, for example, buy-hold orders, sell orders, stop orders, stop-loss orders, and so forth. After a payout, the user's skill value is increased or decreased by the payout amount.

After completion of a game (i.e., after a payout event occurs), a leaderboard is updated to reflect the user's performance (block 208). This can be performed, for example, by leaderboard module 112e, which maintains a leaderboard that lists users and their corresponding skill levels. Each user can be ranked with respect to the other users, such that a user can view his skill level and compare it against those of other users.

The user can opt to play another game (block 210), whereby another game is played (block 206), and the leaderboard can be updated after completion of the additional game (block 208). In this manner, the user can continue to play additional games, as desired, that further increase or decrease his skill level.

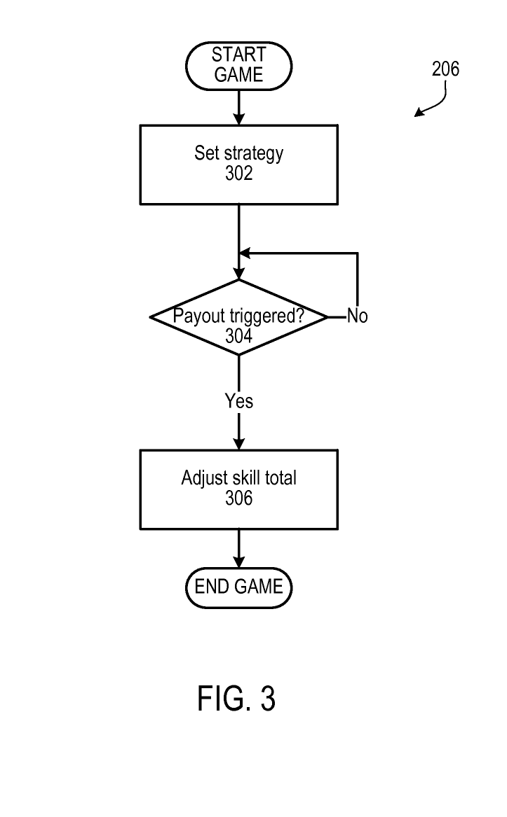

An example of the process 206 of playing a single game is shown in greater detail in FIG. 3. The user begins by setting a strategy (block 302) (i.e., defining when and/or how to enter a position). In this case, a strategy includes selection of a financial instrument and selection of a transaction order with respect to the financial instrument. As an example, a strategy can include an order to buy a particular financial instrument. As another example, a strategy can include an order to sell a particular financial instrument. In some implementations, a strategy can include a condition order that is executed when specified value and/or temporal conditions are met. As an example, a strategy can include a condition that a buy order occurs only if the value of the instrument is within a certain range (i.e., a limit price order). As another example, a strategy can include a buy order that occurs immediately upon submission (i.e., a market price order). As a further example, a strategy may specify multiple conditions for orders to be bought or sold in multiple financial instruments at various times.

A strategy can also include one or more additional parameters that define a payout event (i.e., “trigger conditions”). These trigger conditions define when and/or how to exit all open positions. In some implementations, a trigger condition can specify that the payout event occurs only when the strategy is manually canceled by the user. In some implementations, a trigger condition can specify a conditional order that is executed when certain criteria are met, in order to counteract an earlier transaction order. As an example, a strategy can include an order to buy a particular financial instrument, with a conditional order to sell the instrument (i.e., to trigger a payout) when it crosses a specified value threshold. This threshold can be, for example, greater than the current value of the financial instrument (i.e., a profit price), or less than the current value of the financial instrument (i.e., a stop price). As another example, a strategy can include an order to buy a particular financial instrument, with a conditional order to sell the instrument when a certain time has elapsed. As yet another example, a strategy can include an order to sell a particular financial instrument, with a conditional order to buy the instrument (i.e., to trigger a payout) when it crosses a specified value threshold. A strategy can include one or more trigger conditions in order to reflect the user's forecasts regarding the future value of the selected financial instrument. However all trigger conditions result in the net open position of the strategy becoming zero.

A user can select a strategy in various ways. For instance, a user can select a strategy and enter corresponding parameters into a user interface 132a-d on a computer 130a-d. The user can enter this information using text-based input (e.g., by typing alphanumeric characters representing strategy and parameter selections), input from a graphical interface (e.g., by selecting elements on a visual representation of information), or a combination of input techniques.

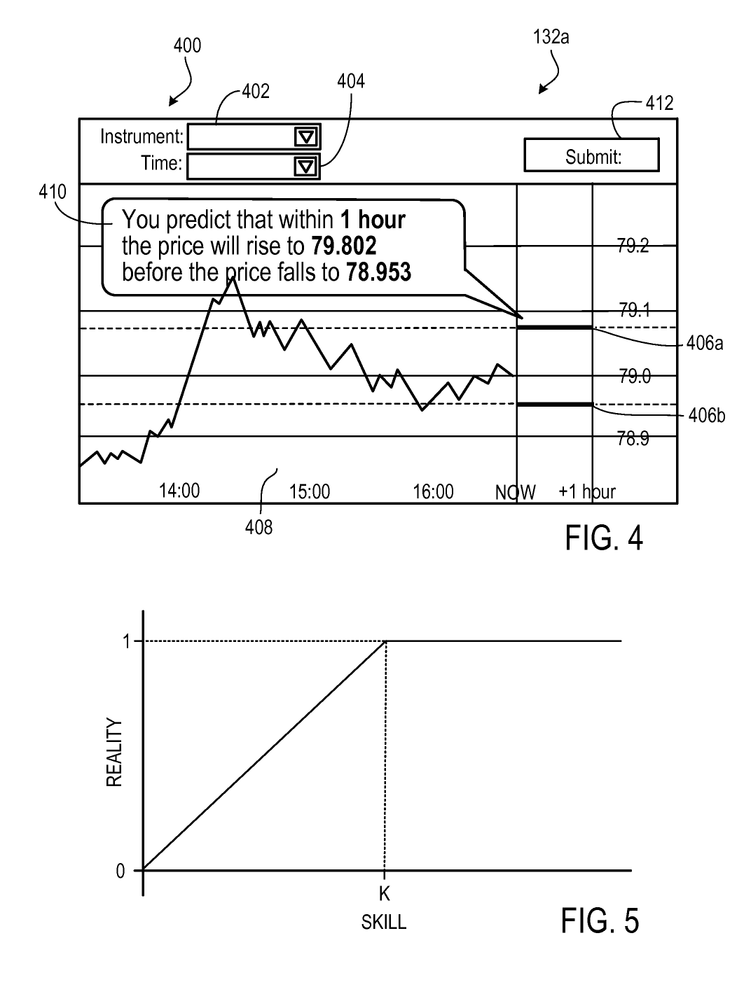

For instance, referring to FIG. 4, a user interface 132a can display an example strategy selection dialog 400 that allows a user to select a strategy and enter corresponding parameters. Dialog 400 includes several elements, including an instrument selection portion 402, a time selection portion 404, value threshold selection portions 406a-b, instrument data portion 408, help portion 410, and confirmation portion 412. Information can be entered into each of these portions in various ways, for instance by way of a selection box, a text entry field, a check box, a selectable graphical element, and so forth. Instrument selection portion 402 allows the user to specify a financial instrument. When the user selects a financial instrument, instrument data portion 408 updates in order to display relevant information about the selected instrument. For example, instrument data portion 408 can display a chart showing an historical plot of the selected instrument's value. Time selection portion 404 allows the user to specify a temporal parameter, for instance a particular length of time that the strategy should run (i.e., a timescale for the strategy). Value threshold portions 406a-b allow the user to enter threshold value parameters, for instance value thresholds that would trigger a payout event. Dialog 400 can also include a help section 410, which can clarify the currently selected strategy and parameters, for instance by summarizing the selections in plain language. The user can confirm the selected strategy and parameters using a confirmation portion 412.

After the user selects a strategy, system 100 determines if and when a payout event has been triggered (block 304), ending the strategy (i.e., exiting all open positions). The triggering of a payout event depends on the strategy that was selected. For instance, if the user selected a strategy that includes a trigger condition specifying a threshold value for a payout event, a payout event is triggered if the value of the instrument matches or crosses the threshold value. As an example, a user selects a financial instrument having a value of 10, and specifies that the instrument should be sold if the instrument either meets or exceeds 15, or meets or falls below 5. When the value of the instrument increases over time to 10, a payout event is triggered. As another example, if the user selected a strategy that included a trigger condition specifying a timescale parameter, the payout event is triggered when the specified length of time elapses. As a result, the time between the beginning of a strategy and the end of the strategy (i.e., the triggering of a payout event) can vary depending on the instrument, the change in value of the instrument, and the user's strategy. As yet another example, if the user selected a strategy that included a trigger condition specifying that the payout event occurs only when the strategy is manually canceled by the user, the payout event is triggered when the user cancels the strategy. In some implementations, regardless of the specified trigger condition, the user can cancel a strategy (e.g., to simulate immediately buying or selling the instrument) in order to immediately trigger a payout event.

After a payout event is triggered, the user's skill value is adjusted (block 306) based on the completion of the strategy. The value of the adjustment can depend on several factors, for instance the “market return” value (i.e., a value that represents a simulated investment return for entering and exiting a position, for example for purchasing and subsequently selling an instrument, or for selling and subsequently purchasing an instrument). This value can depend on several factors, for instance the value of the instrument when the strategy began and the value of the instrument when the payout event was triggered. As an example, if the user selected an instrument that increased in value from 10 to 15 during the course of the strategy, the user's skill value can be adjusted positively in order to reflect this success. For instance, in some implementations, the user's skill value can be increased by five Game Points. In another example, if the user selected an instrument that decreased in value from ten to five during the course of the strategy, the user's skill value can be adjusted negatively in order to reflect this setback. For instance, in some implementations, the user's skill value can be decreased by five Game Points.

In some implementations, the adjustment of a user's skill value can depend on an “entry cost”. The entry cost value acts as a cost to the player for starting the given strategy, and can be used to simulate transaction costs typically associated with financial transactions. This entry cost can simulate, for example, costs commonly incurred in real-world financial market trading, such as bid-offer spread, slippage, and broker fees. In some implementations, the entry cost is determined based on a simulation of expected or “worst-case” transaction costs that would be associated with executing the selected strategy in a real-world market. In some implementations, this simulation may be based on live data from a financial market, such as market bids and offers at the time of simulated trading, estimated trading and settlement costs, and slippage from observed values caused by, for example, system and network latencies. In some implementations, the entry cost varies based on the financial instrument. In some implementations, the entry cost is a constant pre-determined value, for example 0, 50, 100 or 150 Game Points. In some implementations, the entry cost is determined by the specific financial instruments used in the strategy. In some implementations, the entry cost is a function of the current market-data from the specific financial markets used in the strategy. In some implementations, the entry cost can be adjusted, for example, by the operators of game module 110.

In some implementations, the adjustment of a user's skill value can depend on a “bonus value.” The bonus value determines how much skill a user receives or loses upon ending a strategy and triggering a payout event. The bonus value can be used to simulate the return of part of the entry cost, for instance if the prediction of the entry cost was pessimistic (i.e., higher than the actual cost). For instance, if the initial entry cost was too high, the user's skill value will be increased by a bonus value that represents the difference between the predicted entry cost and the actual cost. In some implementations, the bonus value is determined based on the selected strategy. For example, in some implementations, the bonus value is one half of the entry cost, and is added only if the strategy exited its position using a limit price order, as opposed to a market price order. In this manner, the user's skill adjustment may better reflect the simulated net returns of trading and thus incent a better trading style.

In some implementations, the adjustment of a user's skill value can depend on a “confidence value.” The confidence value is a strategy parameter that a user can specify during the selection of a strategy, and reflects how confident the user is in a positive result. The confidence value is a positive value, and acts as a “multiplier” that multiplies the user's skill adjustment when a payout event is triggered. For instance, in an example implementation, the confidence value defaults to one, and the user's skill value is adjusted based on factors other than the confidence value. If instead the user selects a confidence value of two, the user's skill value is adjusted by two times the default adjustment. If instead the user selects a confidence value of 0.5, the user's skill value is adjusted by half the default adjustment. In this manner, the user can increase the risk of his strategy depending on his confidence in his strategy's chances for success. In some implementations, the range of confidence values is capped, for instance at two, so that a user cannot select confidence values greater than the capped value.

In some implementations, the adjustment of a user's skill value can depend on a “reality value” that is assigned to each user. The reality value is a parameter that represents how close the skill level adjustment reflects a real-world transaction, and can be used to provide a handicap to users of lower skill. For instance, in some implementations, the reality value is a positive value between zero and one, and acts as a multiplier of the entry cost and the exit bonus, and the market returns if they are negative. Depending on the skill level of a user, the reality value can vary between one (for high skill players) to 0 (for low skill players), such a player initially incurs no entry costs for each strategy, and incurs increasing entry costs as she increases in skill. In some implementations, the reality value for each player can be represented as a function that depends on the user's skill level. An example reality value function is shown in FIG. 5, in which the reality value increases as a function of skill level until the skill level exceeds a constant value k, after which the reality value remains at one. Other reality value functions can be used, and can include continuous functions, discontinuous functions, or combinations of functions.

After completion of a strategy, the skill level adjustment can be calculated using a function based on the market return value, the bonus value, the confidence value, and/or the reality value. For example, in some implementations, the skill level adjustment A can be calculated using the functions below:

### For Positive Market Returns:

A=(marketReturns+(exitBonus−entryCost)*reality)*confidence,

otherwise:

A=(marketReturns+exitBonus−entryCost)*reality*confidence,

where marketReturns is the market return value, exitBonus is the bonus value, entryCost is the entry cost value, reality is the reality value, and confidence is the confidence value.

In some implementations, skill level adjustment values are based on a logarithmically proportional difference in instrument value over the course of the strategy. This may be beneficial in some implementations, as it can reduce compounding effects on a user's skill level over time, and can allow a more meaningful comparison of user skill levels across time periods. In a simplified example that depends only on market return, the skill level adjustment A can be calculated using the function below:

$$A = Convert ( log ( \frac{{value}_{end}}{{value}_{begin}} ) * side ) ,$$

where log is the natural logarithm function, value_{begin} is the value of the instrument at the beginning of the strategy, value_{end} is the value of the instrument at the end of the strategy (i.e., when the payout event is triggered), side is the value 1 or −1 and indicates the expected direction of price movement, and Convert is a conversion function.

In some implementations, Convert is a constant multiplier. For example, in some implementations, Convert(x)=(1000000*x), so that a market return of 1% (0.01) would result in a skill level adjustment of 10,000 Game Points.

In some implementations, Convert is a multiplier function with a multiplication factor that varies based the type of financial instrument, and can be used to adjust for trading risk caused by differences in market liquidity for different types of financial instruments. For example, Convert may be defined so that a 1% (0.01) return in any currency may result in a skill level adjustment of 10,000 Game Points, but an equivalent 1% (0.01) return in a stock may result in a skill level adjustment of 500 Game Points. In this manner, the liquidity (i.e., ability to profit) of strategies involving different types of financial instrument can be adjusted and/or balanced against those of other types of financial instruments.

In some implementations, the skill level adjustment values can be rounded, for instance to the nearest integer value.

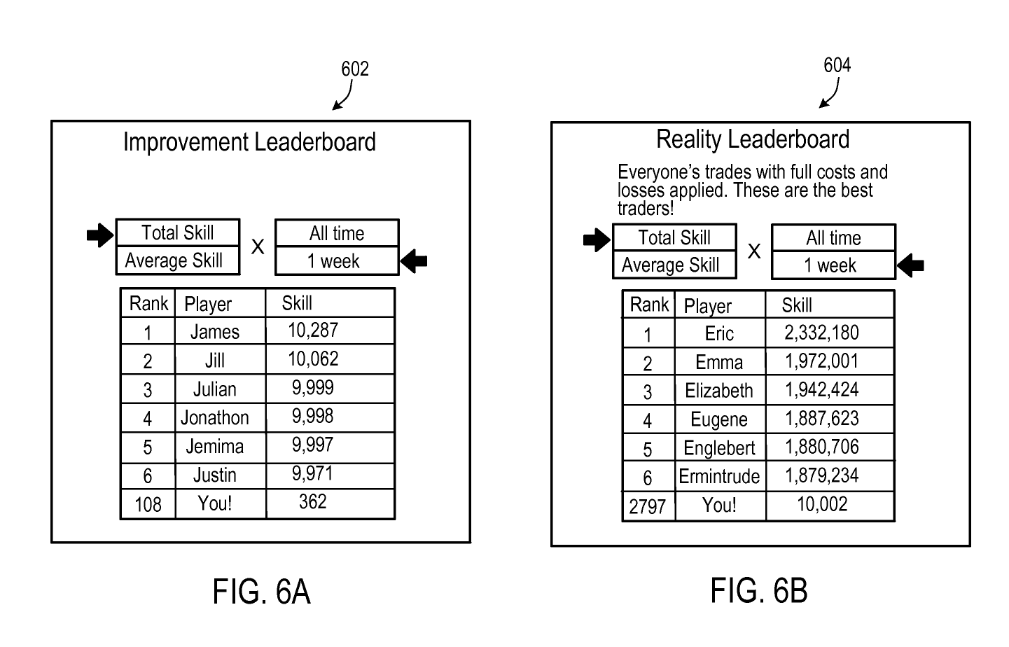

In some implementations, one or more leaderboards are maintained that describe the performance of the users. Leaderboards can be used to describe performance in difference ways. For instance, as shown in FIG. 6A, an “improvement” leaderboard 602 ranks users based on the sum of all payouts from all games played, either over the entire timespan of the system 100 (i.e., “all time”) or from the start to the end of a particular time period (e.g., one week, one month, one year, and so forth). In some implementations, as shown in FIG. 6B, a “reality” leaderboard 602 can be used that ranks users based on a “realistic” calculation of their performance. For example, in some implementations, reality leaderboard 604 is based on the sum: (marketReturns+exitBonus−entryCost)*confidence, for all games played from the start to the end of the time period. In some implementations, improvement leaderboard 602 can favor players with relatively low skill values (e.g., players who have recently starting playing games), whereas the reality leaderboard 604 can indicate who would have made the biggest returns if they had actually traded on a real-world market. In this manner, different leaderboards can be maintained to represent different performance aspects of the users.

In some implementations, one or more of the following features may be present. For example, the leaderboard module 112e can use leaderboards to determine additional awards (i.e., “prizes”). The awards may be made at some pre-determined schedule, for example according to a publicized schedule of events. The awards may total a specified amount (i.e., a “fixed pot”). In some implementations, prize pots can be created for recurring time periods (e.g., daily, weekly, monthly, and so forth) that are determined in advance and made publically known. Furthermore, additional pots can be made available in the same way for individual financial instruments or strategies. In some implementations, differing pots are available for each of the “Reality” and “Improvement” leaderboards.

In some implementations, at the end of the respective time period, the system determines the top N users on one or more of the leaderboards, and divides the promised pot between the N players, such that they receive a weighted share of the pot. The user's weight can be based, for example, on his score from the leaderboard.

In some implementations, at the end of the respective time period, the system identifies all users in a specific leaderboard, and pays a weighted share of a total pot, where each user's weight is based on his score from the leaderboard minus a threshold value. Users with zero or negative weight (i.e., users whose leaderboard score does not exceed the threshold value) do not receive anything. In some implementations the threshold value may be made public before the end of the time period. In some implementations the pot is fixed and made public at the start of the time period. In other implementations the pot is a function of the number of players with a positive weight, and is determined at the end of the period. In some implementations the allocations are adjusted to ensure that all players who have a positive weight receive at least some minimum payout.

In some implementations, prizes may be awarded for overlapping time periods. For instance, in some implementations awards may be made weekly based on performance data obtained over the prior six months.

In some implementations, leaderboards are updated according to a “marking to market” process. That is, the leaderboards describe the performance of users as if all the currently active games were immediately canceled and paid out. This provides a snap-shot of each user's performance at an arbitrary point in time, and allows users to compare their performance against the performance of others, factoring in both completed and active games. This also allows the leaderboards to publically display the performance of the users without publically revealing each of the user's active games. In some implementations, the leaderboards update periodically according to the marking to market process, for example daily, weekly, monthly, yearly, and so forth. In some implementations, prizes can be periodically awarded according to the marking to market process. As an example, awards may be made weekly based on marked to market performance data obtained over the prior six months. This allows users to compete for awards based on their performance in both completed and active games, and removes any ability for a user to artificially present a higher score in the award by leaving games that are losing points running until after the awards have been made.

In some implementations a user may use a special link to invite non-users to register for an account. For example, the special link can cause the system to recognize the invitation and the inviting user (i.e., the inviter). In some implementations, if the invitee has been invited by multiple users before joining, the system will choose the user whose link was most recently used as the inviter. In some implementations, the inviter may receive a bonus for inviting someone. This bonus can, for example, be in the form of Game Points, unlock credits, real-world currency, or other bonus. In some implementations the bonus may a fixed value or the bonus may be a percentage of the invitee's payouts over the lifetime of the invitee's account. In some implementations, the bonus may be a percentage of the invitee's payouts for a limited time period after the invitee registers.

In some implementations awards are measured in a fixed currency such as U.S. Dollars. In some implementations, awards are measured in credits that themselves have no nominal value, but that may be exchanged for standard currencies, or for other objects of value, either by the system operator or by external service providers.

In some cases, a user's accrued payouts may be redeemed, for instance, in the form of awards to Charities, bank transfer, receipt of a check, receipt of store vouchers, receipt of cash-like instruments such as Bitcoins, receipt of other goods or services. The list of available redemption options may depend on the player's country of residence and the laws of said country.

In some implementations, the system uses the full history of a player's unadjusted payouts to determine and display a yearly compounded return and the standard deviation of that return. Such information can represent a standardize measure of a user's performance. For example, higher returns and lower standard deviations may indicate a skilled player.

A number of implementations have been described. Nevertheless, it will be understood that various modifications may be made without departing from the spirit and scope of the invention.

For example, in some implementations, a strategy can include the selection of multiple financial instruments and/or a selection of multiple transaction orders with respect to the financial instruments.

In some implementations, the user can only select a financial instrument from a limited list of financial instruments. For example, the list may be restricted to financial instruments of a certain type, value, or based on other considerations. In some implementations, the list can be modified, either to make additional financial instruments available to users, or to remove financial instruments from user consideration. The list can be modified for all users (e.g., to revise the list of financial instruments that are available to all users), and/or it can be modified for individual users (e.g., to “unlock” certain instruments for selected players).

In some implementations, the user can only select a strategy from a limited list of strategies. In some implementations, the list can be modified, either to make additional strategies available to users, or to remove strategies from user consideration. The list can be modified for all users (e.g., to revise the list of strategies that are available to all users), and/or it can be modified for individual users (e.g., to “unlock” certain strategies for selected players).

In some implementations, users can unlock (i.e., gain access to) restricted game elements in various ways. For instance, in some implementations, a user can unlock elements by performing one or more tasks specified by the operators of game module 110. As an example, a user can unlock a strategy by completing an instructional tutorial regarding the use of the strategy. In some implementations, a user can unlock elements by exceeding a particular skill level. In some implementations, a user can unlock elements based on his performance on a test administered by game module 110.

In some implementations, a user can unlock elements by purchasing the elements using currency, for example real currency (e.g., U.S. dollars) or in-game currency (e.g., “unlock credits”). In some implementations, the system maintains an in-game currency account for each player, where each player starts with an initial amount of currency, and can earn additional currency by performing certain specified tasks. The user can use this currency to unlock restricted game elements.

In some implementations, a user can play more than one game concurrently. For example, a user can play the same strategy on two different financial instruments concurrently. As another example, a user can play different strategies on the same financial instrument concurrently.

In some implementations, there are restrictions on playing games concurrently. For example, in some implementations, concurrent games may not be played at all. In another example, in some implementations, concurrent games may not be played for the same instrument. In yet another example, in some implementations, concurrent games for the same instrument can only be played if the games differ in timescales by a specified degree. This specified degree can differ. For instance, in some implementations, multiple games for the same financial instrument may only be played when the timescale for one game is at least four times greater than the timescale for another game. This degree of difference can be adjusted, for instance by the operators of game module 110.

In some implementations, playing concurrent games requires that the strategies chosen for those games are cancelable. In some implementations, transactions for concurrent games are handled according to a “marking to market” process. That is, in the event that a second or further game is started, all the currently active games will be canceled and paid out, and then new games will be automatically started at the current time using otherwise the same parameters as before. Only once these games have restarted may the player's new game then start. In some implementations, when multiple games are active, each game's payout will be multiplied by an “allocation” of between zero and 100%, such that the sum of all allocations exactly equals 100%. If one of the multiple concurrent games is subsequently canceled, all remaining games are marked-to-market.

In some implementations, playing concurrent games requires that the strategies chosen for those games are cancelable and that the player choose the allocation between games (where the allocation sums to 100%). Subsequent changes to the allocation will require games to be marked-to-market at that time.

Various aspects of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus” and “computer” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Other implementations are within the scope of the invention.

What is claimed is:

1. A system for playing a game comprising:
an input module that receives a strategy from a player, the strategy comprising at least one trigger condition;
a trigger module that determines if the trigger condition has been met; and
an adjustment module that calculates a skill adjustment value based on the strategy and adjusts a skill level for the player based on the skill adjustment value.

2. The system of claim 1, wherein the strategy further comprises a confidence value.

3. The system of claim 1, wherein the strategy corresponds to a simulated financial transaction.

4. The system of claim 1, wherein the strategy corresponds to a plurality of simulated financial transactions and the trigger condition corresponds to a condition to counteract the simulated financial transactions.

5. The system of claim 3, wherein the trigger condition corresponds to a condition to counteract the simulated financial transaction.

6. The system of claim 1, wherein the input module receives a plurality of strategies from a plurality of players, each strategy comprising at least one respective trigger condition;
wherein the trigger module determines if each of the trigger conditions has been met; and
wherein the adjustment module calculates a respective skill adjustment value for each of the strategies and adjusts the skill level for each player based on the corresponding skill adjustment value.

7. The system of claim 6, further comprising a leaderboard module that determines a leaderboard corresponding to the skill levels of the players.

8. The system of claim 1, wherein the adjustment module calculates the skill adjustment value based on a determination of a simulated valuation change of a financial instrument.

9. The system of claim 8, wherein the simulated valuation change corresponds to a difference in valuation between a simulated position entry time and a simulated position exit time.

10. The system of claim 8, wherein the simulated valuation change corresponds to a logarithm of a difference in valuation between a simulated position entry time and a simulated position exit time.

11. The system of claim 1, wherein the adjustment module calculates the skill adjustment value further based on a current skill level of the player.

12. The system of claim 1, wherein the adjustment module calculates the skill adjustment value further based on a simulated market liquidity of specific financial instruments used by the strategy.

13. The system of claim 1, wherein the adjustment module calculates the skill adjustment value further based on a type of the strategy.

14. The system of claim 1, wherein the adjustment module calculates the skill adjustment value further based on an entry cost value corresponding to a simulated transaction cost estimate.

15. The system of claim 14, wherein the adjustment module calculates the skill adjustment value further based on a bonus value corresponding to a difference between the simulated transaction cost estimate and a simulated actual transaction cost.

16. The system of claim 2, wherein the skill adjustment value is a multiple of the confidence value.

17. The system of claim 1, further comprises a registration module that that records identifying information corresponding to one or more players.

18. The system of claim 12, wherein the identifying information comprises a telephone number.

19. The system of claim 13, wherein the registration module sends a message comprising a confirmation code to a device associated with the telephone number.

20. The system of claim 14, wherein the registration module verifies the identifying information by receiving the confirmation code from the device associated with the telephone number.

21. The system of claim 7, wherein the leaderboard module determines an award and a recipient of the award based on the skill levels of the players.

22. The system of claim 21, wherein the leaderboard module determines the award and the receipt of the award based on a threshold skill value.

23. The system of claim 22, wherein players with skill levels greater than the threshold skill value each receive corresponding weighted portions of the award, and wherein players with a skill level less than the threshold value do not receive the award.

24. The system of claim 23, wherein the weighted portions of the award depend on the players' skill levels.

25. The system of claim 7, wherein the leaderboard module determines the award further based on the number of players.

26. The system of claim 7, wherein the leaderboard module determines the award and the recipient of the award further based on changes to the skill levels of the players during a pre-determined time period.

27. The system of claim 7, wherein the leaderboard module determines a plurality of awards and a plurality of recipients of the awards further based on changes to the skill levels of the players during each of a plurality of pre-determined overlapping time periods.

28. A computer-implemented method of playing a game, the method comprising:
receiving, in an input module a strategy from a player, the strategy comprising at least one trigger condition;
determining, using a trigger module, if the trigger condition has been met;
calculating, using an adjustment module, a skill adjustment value based on the strategy;
adjusting, using the adjustment module, a skill level for the player based on the skill adjustment value; and
displaying information regarding the skill adjustment value to the player through a user interface.

29. The computer-implemented method of claim 28, wherein the strategy further comprises a confidence value.

30. The computer-implemented method of claim 28, wherein the strategy corresponds to a simulated financial transaction.

31. The computer-implemented method of claim 28, wherein the strategy corresponds to a plurality of simulated financial transactions and the trigger condition corresponds to a condition to counteract the simulated financial transactions.

32. The computer-implemented method of claim 30, wherein the trigger condition corresponds to a condition to counteract the simulated financial transaction.

33. The computer-implemented method of claim 28, further comprising:
receiving, in the input module, a plurality of strategies from a plurality of players, each strategy comprising at least one respective trigger condition;
determining, using the trigger module, if each of the trigger conditions has been met;
calculating, using the adjustment module, a respective skill adjustment value for each of the strategies; and
adjusting, using the adjustment module, the skill level for each player based on the corresponding skill adjustment value.

34. The computer-implemented method of claim 33, further comprising determining, using a leaderboard module, a leaderboard corresponding to the skill levels of the players.

35. The computer-implemented method of claim 28, wherein calculating the skill adjustment value comprises determining, using the adjustment module, a simulated valuation change of a financial instrument.

36. The computer-implemented method of claim 35, wherein the simulated valuation change corresponds to a difference in valuation between a simulated position entry time and a simulated position exit time.

37. The computer-implemented method of claim 35, wherein the simulated valuation change corresponds to a logarithm of a difference in valuation between a simulated position entry time and a simulated position exit time.

38. The computer-implemented method of claim 28, wherein the skill adjustment value calculation is further based on a current skill level of the player.

39. The computer-implemented method of claim 28, wherein the skill adjustment value calculation is further based on a simulated market liquidity of specific financial instruments used by the strategy.

40. The computer-implemented method of claim 28, wherein the skill adjustment value calculation is further based on a type of the strategy.

41. The computer-implemented method of claim 28, wherein the skill adjustment value calculation is further based on an entry cost value corresponding to a simulated transaction cost.

42. The computer-implemented method of claim 41, wherein the skill adjustment value calculation is further based on a bonus value corresponding to a difference between the simulated transaction cost estimate and a simulated actual transaction cost.

43. The computer-implemented method of claim 29, wherein the skill adjustment value is a multiple of the confidence value.

44. The computer-implemented method of claim 34, further comprising determining, using the leaderboard module, an award and a recipient of the award based on the skill levels of the players.

45. The computer-implemented method of claim 39, wherein determining the award and the recipient of the award is further based on a threshold skill value.

46. The computer-implemented method of claim 40, wherein players with skill levels greater than the threshold skill value each receive corresponding weighted portions of the award, and wherein players with a skill level less the threshold value do not receive the award.

47. The computer-implemented method of claim 41, wherein the weighted portions of the award depend on the players' skill levels.

48. The computer-implemented method of claim 41, wherein determining the award is further based on the number of players.

49. The computer-implemented method of claim 34, wherein determining the award and the recipient of the award is further based on changes to the skill levels of the players during a pre-determined time period.

50. The computer-implemented method of claim 34, further comprising determining, using the leaderboard module, a plurality of awards and a plurality of recipients of the awards further based on changes to the skill levels of the players during each of a plurality of pre-determined overlapping time periods.
